(19) United States
(12) Patent Application Publication
(10) Pub. No.: US 2005/0177858 A1
(43) Pub. Date: Aug. 11, 2005

(54) Reproduction apparatus and digest reproduction method

(76) Inventor: Eiji Ueda, HIROSHIMA (JP)

Correspondence Address: WENDEROTH, LIND & PONACK, L.L.P., 2033 K STREET N. W., SUITE 800, WASHINGTON, DC, 20006-1021, US

(21) Appl. No.: 10/510,159

(22) PCT Filed: Apr. 23, 2004
(86) PCT No.: PCT/JP04/05856

(30) Foreign Application Priority Data
May 9, 2003 (JP) 2003-132320

(51) Int. Cl. H04N 7/173

(52) U.S. Cl. 725/105

(57) ABSTRACT

There is provided a reproduction apparatus which acquires information concerning a program digest, which is created by a third party, and performs a digest reproduction of a recorded program based on this information, while taking into consideration factors such as unreproduced portions of the recorded program and the amount of time which a user can spend for viewing, for example. From a recording/reproduction processing section (24), a digest information management section (27) acquires information concerning a recording process and a reproduction process, and based on such information, generates predetermined program recording information and predetermined program reproduction history information. From a server (40) on a network (30), the digest information management section (27) acquires server digest information which is previously stored therein. The program recording information, the program reproduction history information, and the server digest information are recorded on the hard disk (25) and kept under management therein. From such information, the digest information management section (27) generates predetermined user digest information, and, in accordance with this user digest information, provides the user with information concerning a digest reproduction of the recorded program.

### TECHNICAL FIELD

The present invention relates to a reproduction apparatus and a digest reproduction method, and more particularly to a digest reproduction method for recorded programs, which is executed by an apparatus for performing a reproduction process of recorded programs, and a reproduction apparatus to which the same method is applied.

### BACKGROUND ART

In recent years, hard disk recorders which employ a hard disk as a recording medium are gaining popularity as devices for recording and reproducing programs. As compared to conventional devices which employ a VHS video cassette as a recording medium, for example, hard disk recorders are capable of continuously recording programs for extended periods of time. Due to the rise of hard disk recorders as such, it is expected that the concept of program recording will shift from that in which only previously determined programs are recorded to that in which all programs are recorded anyhow, among which programs to be viewed or saved are determined later (continual recording).

When determining whether one needs a program which has been recorded under the concept of continual recording or the like but which is still unreproduced (i.e., not viewed yet), it would be very convenient if main scenes from the program can be reproduced in digest form because it would allow one to confirm the content of the program in a short period of time. Accordingly, various techniques for generating and providing program digests are contemplated.

A first conceivable technique is a technique in which a hard disk recorder automatically generates a digest. In this case, however, the hard disk recorder can no more than extract portions to be reproduced in digest form in a mechanical manner, i.e., every time a scene change is detected or at predetermined time intervals, irrespective of the contents of the program. Therefore, it is very difficult to generate a digest which enables pertinent understanding of the contents of the program. Moreover, there is no guarantee that the contents of the generated digest would correspond to the contents which the user of the hard disk recorder wants to know the most.

Therefore, a technique may be conceivable in which a program provider such as a broadcast station or any third party other than the user of the hard disk recorder generates and provides a program index. In this technique, a program provider or a third party generates an index (composed of a program title, absolute time, and the like) for designating the positions of characteristic scenes and scenes of interest within a program, and previously stores such an index in a server or the like. The user of the hard disk recorder receives the provision of the index from the server by using the program title or the like as a search key, and is able to reproduce only a portion of the program in accordance with this index.

However, according to the above technique, the information which is provided from the program provider or a third party to the user of the hard disk recorder is the index. Therefore, if the index which is stored at the server or the like is huge, it becomes troublesome to look for the desired scene within the index according to one's liking.

Moreover, the user needs to determine by himself or herself how much is to be viewed from a point in time designated by the index. As a result, it is possible for the user to view the digest for an unnecessarily long period of time, or may skip an important scene without viewing it. Thus, from the stand point of reproducing a digest, there is not much convenience.

Therefore, an object of the present invention is to provide a reproduction apparatus which, when performing a digest reproduction of a recorded program, makes it possible for the user to obtain optimum digest information according to the contents of the program being recorded, the preferences of the user, or the like, such that the distribution of the program digest information which has been generated by a program provider or a third party can be promoted and that improved ease of use is provided; and a digest reproduction method therefor.

### DISCLOSURE OF THE INVENTION

The present invention relates to a reproduction apparatus for performing a digest reproduction of a recorded program by referring to digest information, the recorded program being a recording of some or all segments of an original program. In order to attain the above object, the reproduction apparatus comprises: a program recording information processing section, a communication section, a server digest information processing section, and a reproduction processing section.

The program recording information processing section is operable to generate program recording information with respect to the recorded program, the program recording information containing information of recorded segments relative to the original program. The communication section is operable to communicate via a network with a server which stores digest information with respect to the original program, the digest information containing information of a digest segment to be used for the digest reproduction. The server digest information processing section is operable to compare the program recording information concerning the recorded program and the digest information corresponding to the recorded program, and acquire, from the server, digest information containing information of digest segments at least some of which coincide with the recorded segments. The reproduction processing section is operable to reproduce the recorded program based on the digest information acquired by the server digest information processing section.

The reproduction apparatus according to the present invention may further comprise a user digest information processing section operable to generate new digest information based on the digest information acquired by the server digest information processing section, the new digest information containing information of a digest segment which is reproducible from the recorded program, wherein the reproduction processing section is operable to reproduce the recorded program further based on the new digest information generated by the user digest information processing section.

The reproduction apparatus may further comprise a program reproduction history information processing section operable to generate, with respect to the recorded program, program reproduction history information containing information of an unreproduced segment, the unreproduced segment being one of the recorded segments which has not been reproduced yet, wherein the user digest information processing section is operable to generate new digest information further based on the program reproduction history information, the new digest information being used for reproducing the unreproduced segment of the recorded program.

The user digest information processing section may be operable to, with respect to a plurality of pieces of digest information stored in the server concerning a given recorded program, subject the digest segments contained in the plurality of pieces of digest information to a logical operation, and further generate new digest information containing information of a digest segment obtained as a result of the logical operation.

It is preferable that the information of the recorded segments and the information of the digest segment are time information described in terms of relative time from the beginning of the program. It is also preferable that the digest information includes at least one kind of information selected from: a broadcast type concerning image quality of the program, a codec type concerning encoding/decoding processes used for the program; information identifying an individual or group that has created the digest information; presence/absence of authentication concerning whether an authentication has been made by the individual or group that has created the digest information; a bit rate concerning motions with in an image pertaining to the digest segment; presence/absence of offset concerning whether there is an offset relative to the digest segment; and a correction amount for the digest segment in a case where there is an offset. The server digest information processing section is operable to determine which digest information to acquire by referring to such information. A correction amount for the digest segment in a case where there is an offset may be available for a charge.

The processes performed by the respective elements of the aforementioned reproduction apparatus may be regarded as part of a digest reproduction method for a program which comprises a sequence of processing steps. That is, a reproduction method comprising the steps of: generating program recording information with respect to the recorded program, the program recording information containing information of recorded segments relative to the original program; communicating via a network with a server which stores digest information with respect to the original program, the digest information containing information of a digest segment to be used for the digest reproduction; comparing the program recording information concerning the recorded program and the digest information corresponding to the recorded program, and acquiring, from the server, digest information containing information of digest segments at least some of which coincide with the recorded segments; and reproducing the recorded program based on the digest information acquired by the server digest information processing section.

The functional blocks composing the aforementioned reproduction apparatus may be implemented as an LSI, which is a type of integrated circuit. The digest reproduction method may be provided in the form of a program for causing a computer to execute the sequence of processing steps. Such a program may be introduced into the computer in a recorded form on a computer readable recording medium.

Thus, according to the present invention, digest information is acquired from a server which is connected via a network, and based on this digest information, digest information corresponding to program segments which have been recorded is generated. As a result, by utilizing a program digest created by a third party, the user of the reproduction apparatus can reproduce a digest that relates to a program segment which the user himself/herself has recorded.

Moreover, according to the present invention, digest information can be generated so as to correspond to, among the program segments having been recorded by the user, only those program segments which have not been viewed by the user (unreproduced segments). As a result, an effective digest reproduction can be realized which prevents redundant viewing, or missing portions of, the digest.

Moreover, according to the present invention, a plurality of pieces of digest information are generated in the case where two or more pieces of digest information are stored in the server for a given program through a logical operation or the like. As a result, the user is able to select an optimum digest to be reproduced according to his or her preferences or viewing conditions, from among a plurality of pieces of digest information which have been generated from various point of views. Thus, it is possible to meet various needs of the user, e.g., wanting to understand the contents of the program through a short digest due to lack of time.

Furthermore, according to the present invention, the program recording information, the program reproduction history information, and the digest information may be described in relative time from the beginning of the program. As a result, it becomes possible to adapt the present invention to an existing program system without altering the program system.

### BRIEF DESCRIPTION OF THE DRAWINGS

FIG. 1 is a diagram illustrating the structure of a system incorporating a recording/reproduction apparatus 20 according to an embodiment of the present invention.

FIG. 2 is a block diagram illustrating an exemplary detailed structure of the recording/reproduction apparatus 20.

FIG. 3 is a block diagram illustrating an exemplary detailed structure of a digest information management section 27.

FIG. 4 is a diagram illustrating an exemplary structure of a program recording information generated by a program recording information management section 272.

FIG. 5A and FIG. 5B are diagrams for explaining information which is set in an intra-program recording index shown in FIG. 4.

FIG. 6 is a diagram illustrating an example of a program recording information table which is recorded on a hard disk 25.

FIG. 7 and FIG. 8 are flowcharts illustrating an exemplary procedure of a program recording process performed by the recording/reproduction apparatus 20.

FIG. 9 is a diagram illustrating an exemplary structure of program reproduction history information which is generated by the program recording information management section 272.

FIG. 10 is a diagram illustrating an example of a program reproduction history information table which is recorded on the hard disk 25.

FIG. 11 is a diagram illustrating an exemplary manner in which intra-program recording index shown in FIG. 10 is updated by a program reproduction history information management section 274.

FIG. 12 is a flowchart illustrating an exemplary procedure of a program reproduction process performed by the recording/reproduction apparatus 20.

FIG. 13 is a diagram illustrating an exemplary structure of server digest information which is generated by a server digest information management section 276.

FIG. 14 is a diagram illustrating an example of server digest information which is stored in a server 40.

FIG. 15 is a diagram for explaining a method for correcting an intra-program recording index in accordance with digest information correction amounts labeled No. 4 in FIG. 14.

FIG. 16 is a flowchart illustrating an exemplary procedure of a digest reproduction process performed by the recording/reproduction apparatus 20.

FIG. 17 and FIG. 19 are diagrams illustrating an exemplary resulting screen of a digest search performed by a server digest information acquisition section 275.

FIG. 18 is a diagram illustrating an exemplary refined condition setting screen for a digest search.

FIG. 20 is a diagram illustrating an exemplary server digest information table which is recorded on the hard disk 25.

FIG. 21 is a diagram illustrating an exemplary structure of user digest information which is generated by a user digest information generation section 277.

FIG. 22 is a diagram illustrating an example of a user digest information table which is recorded on the hard disk 25.

FIG. 23 is a diagram for explaining information which is set in the user digest time information shown in FIG. 22 (where the recorded program has not been viewed yet).

FIG. 24 is a diagram illustrating another example of a user digest information table which is recorded on the hard disk 25.

FIG. 25 is a diagram for explaining information which is set in the user digest time information shown in FIG. 24 (where the recorded program has been partially viewed).

FIG. 26A and FIG. 26B are diagrams illustrating still another example of a user digest information table which is recorded on the hard disk 25.

### BEST MODE FOR CARRYING OUT THE INVENTION

Hereinafter, an embodiment of the present invention will be described, with respect to an exemplary case where the recording/reproduction apparatus is a hard disk recorder.

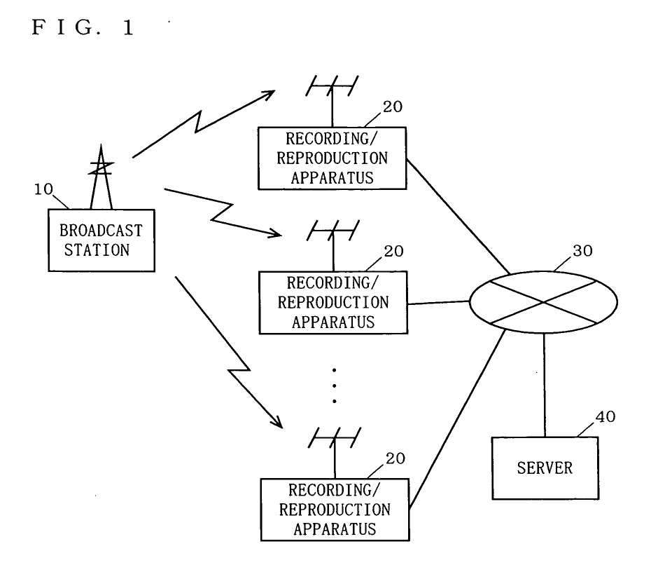

FIG. 1 is a diagram illustrating the structure of a system incorporating a recording/reproduction apparatus 20 according to an embodiment of the present invention. In FIG. 1, the system of the present embodiment comprises a broadcast station 10 which broadcasts a program, one or more recording/reproduction apparatuses 20 which receive the broadcasts, a server 40 for storing information concerning digest reproduction of programs, and a network 30, such as the Internet, for interconnecting the recording/reproduction apparatus 20 to the server 40 so as to be capable of communicating with each other. The details of the recording/reproduction apparatus 20 will be described below.

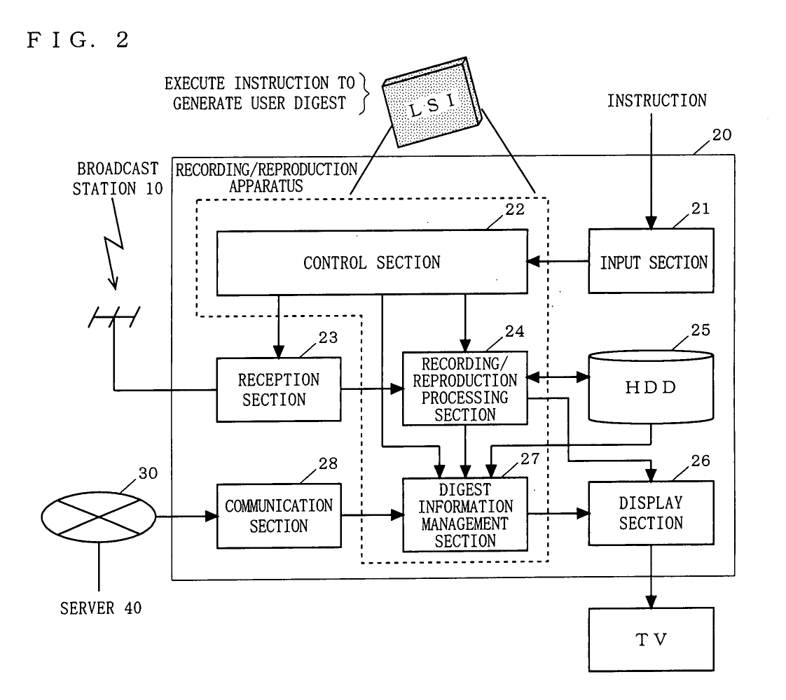

FIG. 2 is a block diagram illustrating a detailed structure of the recording/reproduction apparatus 20 shown in FIG. 1. In FIG. 2, the recording/reproduction apparatus 20 comprises an input section 21, a control section 22, a reception section 23, a recording/reproduction processing section 24, a hard disk (HDD) 25, a display section 26, a digest information management section 27, and a communication section 28.

Via a remote control or the like, the input section 21 accepts instructions to receive programs, and instructions to record the received program and reproduce the recorded program, etc., from the user. Based on the instructions accepted by the input section 21, the control section 22 controls the reception section 23, the recording/reproduction processing section 24, and the digest information management section 27. Typically, the control section 22 is composed of a ROM and/or a RAM storing predetermined processing programs, a CPU for executing such processing programs, a clock section, and the like. The reception section 23, which is composed of a tuner, an encoder, and the like, receives a program via an antenna, and outputs the received program to the recording/reproduction processing section 24. The recording/reproduction processing section 24 performs a process of recording the program received by the reception section 23 to the hard disk 25, and a reproduction process for the program recorded on the hard disk 25. The display section 26, which is composed of a decoder, an OSD generator and the like, outputs the program which has been reproduced by the recording/reproduction processing section 24 in a format suitable for display on a screen, e.g., TV.

From the recording/reproduction processing section 24, the digest information management section 27 acquires information concerning a recording process, and based on this information, generates predetermined program recording information. From the recording/reproduction processing section 24, the digest information management section 27 also acquires information concerning a reproduction process, and based on this information, generates predetermined program reproduction history information. Furthermore, from the server 40 on the network 30, the digest information management section 27 acquires server digest information with which predetermined reproduction condition information is associated, via the communication section 28. The program recording information, the program reproduction history information, and the server digest information are recorded on the hard disk 25 and kept under management therein. From the three kinds of information under its management, the digest information management section 27 generates predetermined user digest information, and, in accordance with this user digest information, provides the user with information concerning a digest reproduction of the recorded program.

Typically, the digest information management section 27 is implemented by software means, as is the control section 22, by a CPU executing a predetermined processing program stored in a ROM or a RAM.

Next, processes to be performed by the digest information management section 27, i.e., a process performed at program recording, a process performed at program reproduction, and a process performed at digest reproduction, will be described.

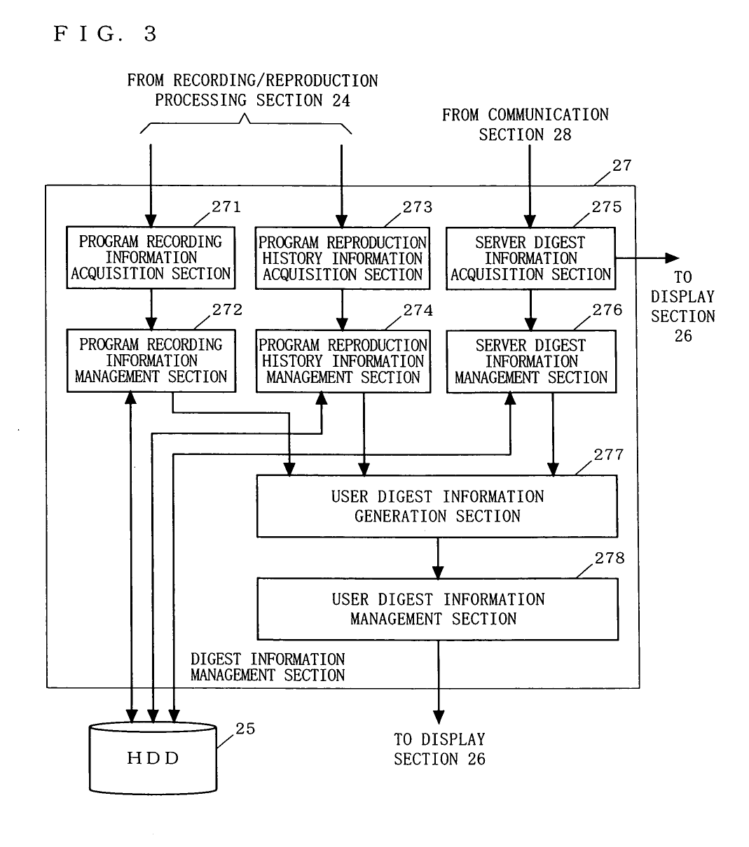

FIG. 3 is a block diagram illustrating a detailed structure of the digest information management section 27 shown in FIG. 1. In FIG. 3, the digest information management section 27 comprises: a program recording information acquisition section 271 and a program recording information management section 272, which constitute processing sections for the program recording information; a program reproduction history information acquisition section 273 and a program reproduction history information management section 274, which constitute processing sections for the program reproduction history information; a server digest information acquisition section 275 and a server digest information management section 276, which constitute processing sections for the server digest information; and a user digest information generation section 277 and a user digest information management section 278, which constitute processing sections for the user digest information.

(1) Process at Program Recording

In accordance with a program recording process performed by the recording/reproduction processing section 24, the program recording information acquisition section 271 acquires predetermined information concerning a program recorded on the hard disk 25 from the recording/reproduction processing section 24. The predetermined information includes: information (program ID) identifying the program; title information of the program; information (file name) identifying a location on the hard disk 25 where the program is recorded; information concerning recorded portions within the program; broadcast type information concerning the image quality of the program; and codec type information concerning encoding/decoding processes used for the program. The program ID and the program title are typically extracted from an electronic program guide (EPG), which is received from the broadcast station 10 together with the program. As for the broadcast type information and the codec type information, these are not essential parts of the predetermined information unless they are to be used for processes which are to performed at digest reproduction (described later).

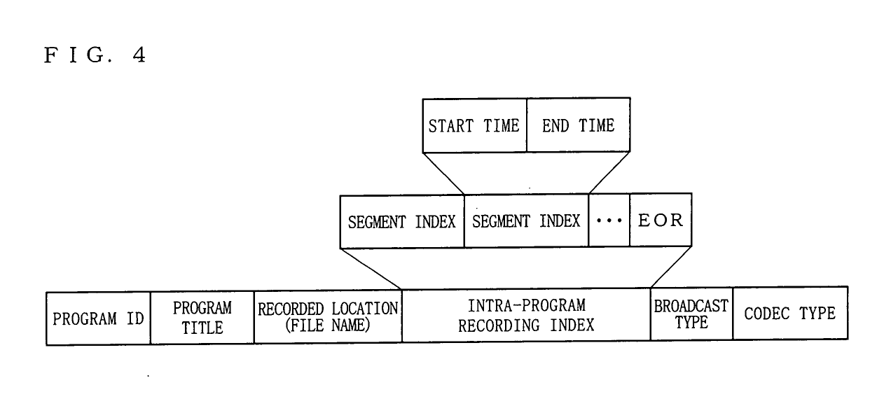

Based on the respective kinds of information acquired by the program recording information acquisition section 271, the program recording information management section 272 generates the program recording information as shown in FIG. 4 on a program-by-program basis. Herein, as an intra-program recording index, the program recording information management section 272 manages information concerning recorded portions within a given program, i.e., information concerning recorded segments. The intra-program recording index is composed of: one or more segment indices, each of which includes paired descriptions of a start time indicating a point in time when a recording was begun and an end time indicating a point in time when the recording was stopped; and an EOR representing the end of the segment index. The start time and the end time are represented as relative points in time from the beginning of the program, e.g., in “minutes”. By using such relative times, there is no need to newly define markers or the like for indicating positions within the program at the side of the broadcast station 10 or the like, thus making it possible to apply an existing program broadcast system without altering it. The manner of providing the programs is not limited to broadcasts, but may also encompass communications, for example.

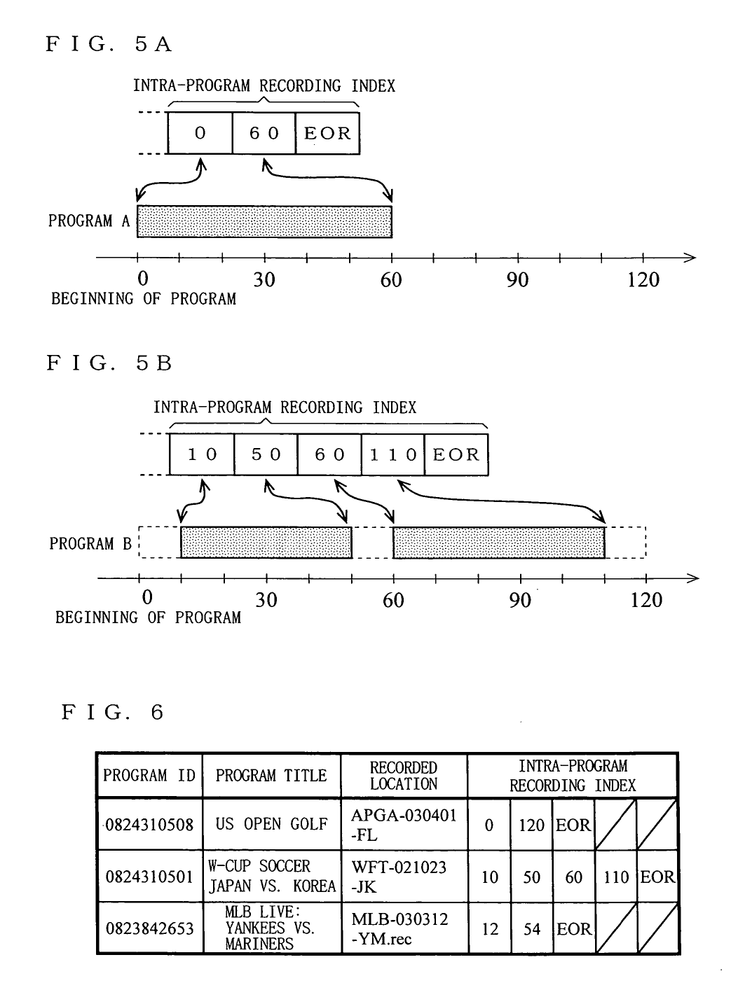

For example, if program A, which is an one-hour program, is recorded from beginning to end, an intra-program recording index composed of a segment index describing a start time “0” and an end time “60” and an EOR will be generated (FIG. 5A). On the other hand, if program B, which is a two-hour program, is recorded in two separate instances, i.e., the 10^{th} to 50^{th} minutes and the 60^{th} to 110^{th} minutes from the beginning of the program, an intra-program recording index composed of a first segment index describing a start time “10” and an end time “50”, a second segment index describing a start time “60” and an end time “110”, and an EOR will be generated (FIG. 5B). The EOR maybe expressed by describing “−1” in both the start time and the end time of a segment index, for example.

The program recording information for all programs is recorded in a predetermined area of the hard disk 25, in the form of a program recording information table as shown in FIG. 6, for example. The example of FIG. 6 illustrates a case where: a golf program is recorded for 120 minutes from the beginning of the broadcast; a soccer program is recorded only between the 10^{th} to 50^{th} minutes and between the 60^{th} to 110^{th} minutes from the beginning of the broadcast; and a baseball program is recorded only between the 12^{th} to 54^{th} minutes from the beginning of the broadcast.

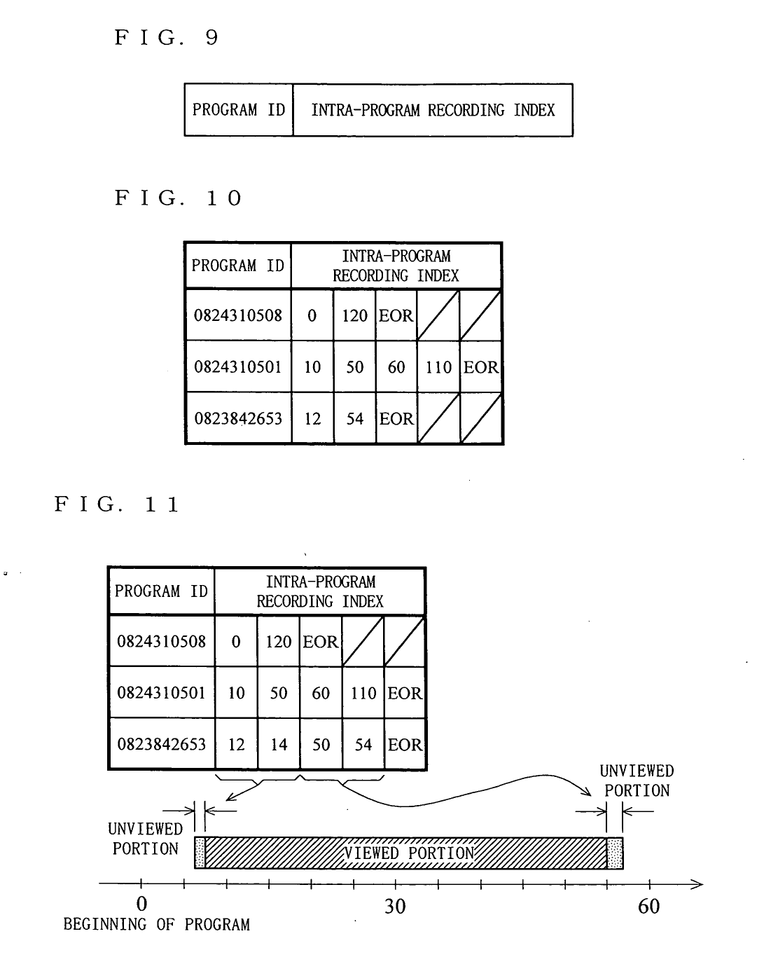

Moreover, at the same time of generating the program recording information, the program recording information management section 272 generates program reproduction history information to be used for the process at program reproduction (described later). The program reproduction history information is in formation representing portions of each recorded program which have not been reproduced by the user, i.e., unreproduced segments. As shown in FIG. 9, the program reproduction history information is composed of the program ID and the intra-program recording index out of the aforementioned program recording information. The program reproduction history information of all recorded programs is recorded in a predetermined area of the hard disk 25, in the form of a program reproduction history information table as shown in FIG. 10, for example.

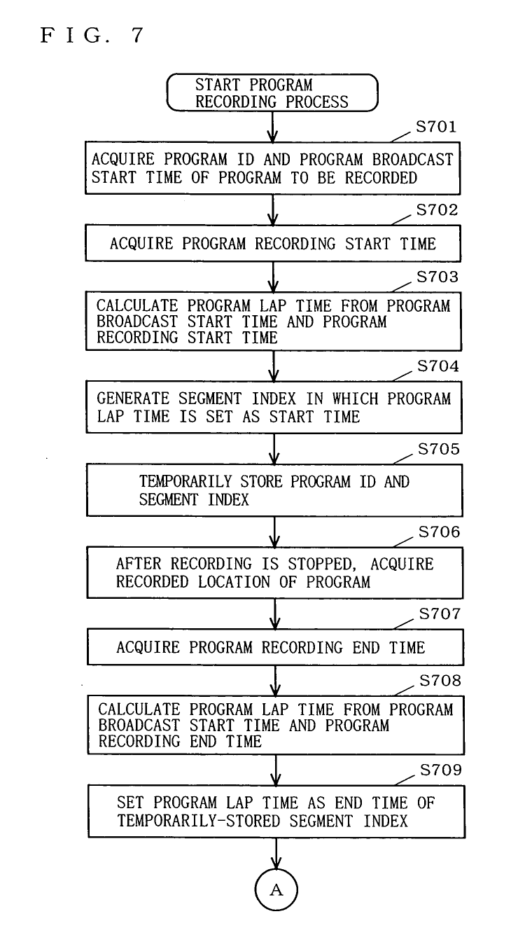

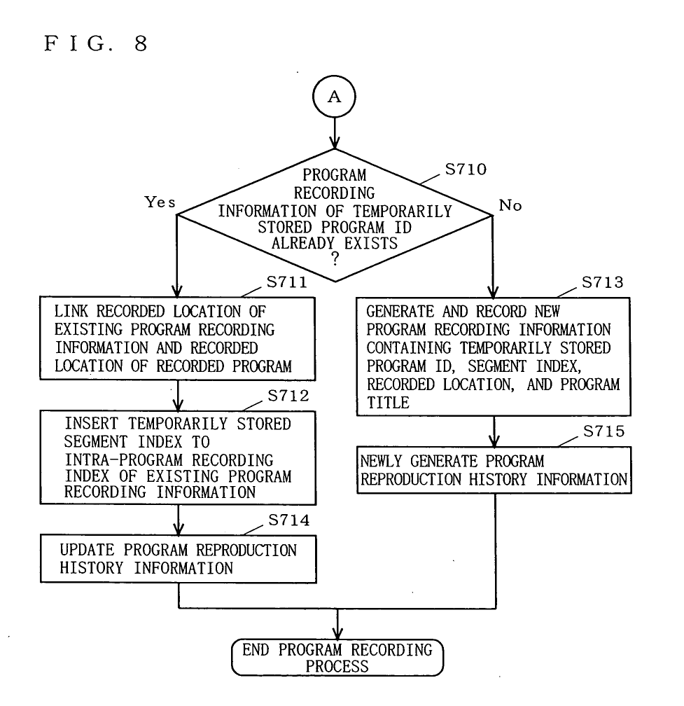

Herein after, with reference to FIG. 7 and FIG. 8, a procedure of generating the program recording information and the program reproduction history information, which is performed at the time of program recording, will be described. FIG. 7 and FIG. 8 are flowcharts illustrating a procedure of a program recording process performed by the recording/reproduction apparatus 20 according to an embodiment of the present invention.

If the recording/reproduction processing section 24 begins recording a received program in accordance with an instruction from the control section 22, the program recording information acquisition section 271 acquires, from the recording/reproduction processing section 24, a program ID of the program to be recorded and a point in time at which the program began to be broadcast (program broadcast start time) (step S701). Moreover, from a clock section or the like provided in the control section 22, the program recording information acquisition section 271 acquires a point in time at which the recording of the program was begun (program recording start time) (step S702). The program ID and the program broadcast start time are to be extracted from the EPG. The program recording information management section 272 calculates a difference between the program broadcast start time and the program recording start time, i.e., a program lap time (step S703). The program recording information management section 272 generates a segment index in which the calculated program lap time is set as the start time (step S704), and temporarily stores the segment index together with the acquired program ID to a vacant area of the hard disk 25 (step S705).

If the recording/reproduction processing section 24 stops the recording of the received program in accordance with an instruction from the control section 22, the program recording information acquisition section 271 acquires a recorded location (filename) of the recorded program from the recording/reproduction processing section 24 (step S706). Moreover, from the clock section or the like, the program recording information acquisition section 271 acquires a time at which the program recording was ended (program recording end time) (step S707). The program recording information management section 272 calculates a difference between the program broadcast start time and the program recording end time, i.e., a program lap time (step S708). Then, the program recording information management section 272 sets the calculated program lap time as the end time of the segment index which was stored to the hard disk 25 at the time of the program recording (step S709).

If one segment index is thus set, the program recording information management section 272 searches through the program recording information table on the hard disk 25 by using the program ID of that segment index as a key, in order to confirm whether program recording information having the same program ID is recorded therein (step S710). If any program recording information having the same program ID is found recorded, the program recording information management section 272 updates the program recording information as follows. First, the recorded location of the existing program and the recorded location of the currently-recorded program are linked (step S711). Next, the segment index which was temporarily stored to the hard disk 25 is inserted in the intra-program recording index of the existing program recording information (step S712). On the other hand, if no program recording information having the same program ID is found recorded, the program recording information management section 272 records a new piece of program recording information to the program recording information table on the hard disk 25, which new piece of program recording information is composed of a program ID, a program title, a recorded location (file name), and the intra-program recording index containing the segment index which was temporarily stored to the hard disk 25 (step S713).

Then, after updating or newly generating the program recording information, the program recording information management section 272 updates or newly generates the program reproduction history information in accordance with that information (step S714, S715).

(2) Process at Program Reproduction

In response to a reproduction process of an already-recorded program stored on the hard disk 25 which is performed by the recording/reproduction processing section 24, the program reproduction history information acquisition section 273 acquires, from the recording/reproduction processing section 24, predetermined information concerning the already-recorded program that has been reproduced. The predetermined information includes a program ID and information concerning the reproduced portions in the program (information representing unreproduced segments). Based on each type of information acquired by the program reproduction history information acquisition section 273, the program reproduction history information management section 274 updates the program reproduction history information shown in FIG. 10.

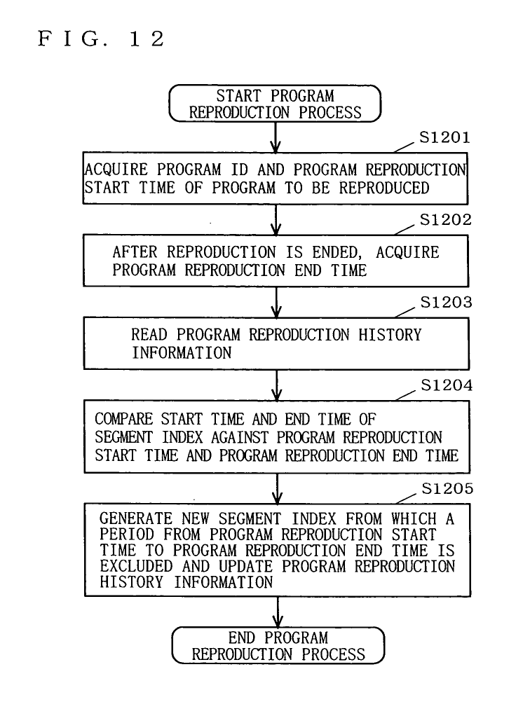

For example, consider a case where a baseball program (program ID: 0823842653) shown in FIG. 6 is only partially reproduced from the 14^{th} to 50^{th} minutes since the broadcast start time, out of what has been recorded. In this case, the unviewed portions of the baseball program which are left after this reproduction are the 12^{th} to 14^{th} minutes and the 50^{th} to 54^{th} minutes from the beginning of the broadcast. Therefore, the program reproduction history information management section 274 updates the program reproduction history information (FIG. 10) of this baseball program to an intra-program recording index which is composed of: a first segment index describing a start time “12” and an end time “14”; a second segment index describing a start time “50” and an end time “54”; and an EOR (FIG. 11).

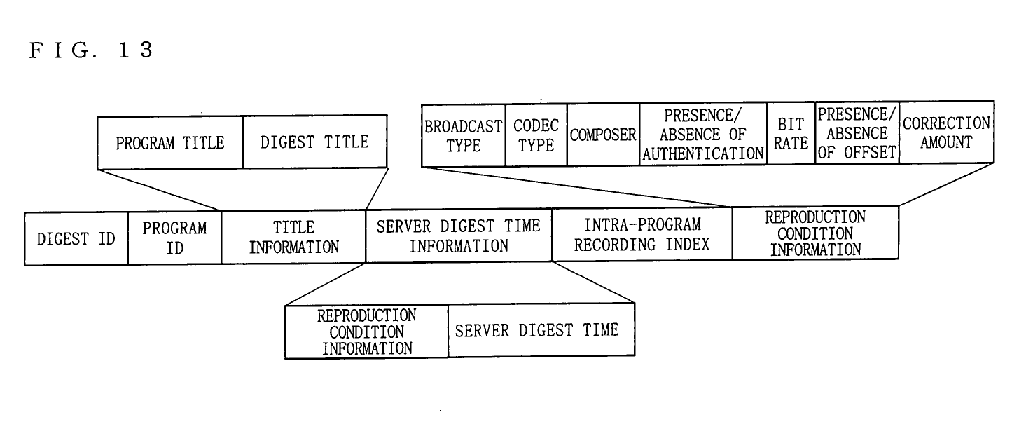

Hereinafter, with reference to FIG. 12, an updating procedure for the program reproduction history information which is performed at the time of program reproduction will be described. FIG. 12 is a flowchart illustrating a procedure of a program reproduction process performed by the recording/reproduction apparatus 20 according to an embodiment of the present invention.

If the recording/reproduction processing section 24 begins reproducing a recorded program in accordance with an instruction from the control section 22, the program reproduction history information acquisition section 273 acquires, from the recording/reproduction processing section 24, a program ID of the program to be reproduced and a time at which program reproduction is to be begun relative to the program broadcast start time (step S1201). If the recording/reproduction processing section 24 ends the reproduction of the recorded program, the program reproduction history information acquisition section 273 acquires, from the recording/reproduction processing section 24, a time at which the program reproduction is to be ended relative to the program broadcast start time (step S1202). The program reproduction history information management section 274 reads from the hard disk 25 a piece of program reproduction history information corresponding to the acquired program ID (step S1203). Next, the program reproduction history information management section 274 compares the start time and the end time of each segment index in the intra-program recording index against the program reproduction start time and the program reproduction end time, respectively (step S1204). Then, the program reproduction history information management section 274 generates a new segment index, from which a period from the program reproduction start time to the program reproduction end time is excluded, thus updating the program reproduction history information (step S1205).

(3) Process at Digest Reproduction

First of all, server digest information for providing digests of broadcast programs is previously stored in the server 40 shown in FIG. 1. It is previously ensured that the server digest information is recorded in a format which matches that of the program recording information (and the program reproduction history information) recorded on the hard disk 25 of the recording/reproduction apparatus 20, as described below. The server digest information may be generated at the broadcast station prior to program broadcasting and previously stored in the server 40. Alternatively, the server digest information may be generated by any arbitrary recording/reproduction apparatus 20 which is connected via the network 30, and stored to the server 40 through uploading.

As shown in FIG. 13, each piece of server digest information is composed of: a digest ID; a program ID; title information which includes a program title and a digest title; server digest time information which includes a broadcast program time and a server digest time; an intra-program recording index; and reproduction condition information which includes a broadcast type, a codec type, a composer, presence/absence of authentication, a bit rate, presence/absence of offset, and correction amounts. The reproduction condition information is information which is utilized when performing a refined search for digest information. Each item of the reproduction condition information is not necessarily essential. Rather, the composer of the digest information may arbitrarily select any of the items to be used.

The digest ID is information which allows unique identification of each digest. The program ID and the program title are the same as the respective information contained in the aforementioned program recording information. The digest title is information representing the content of the digest, which may be arbitrarily set by the person who creates the server digest information. The broadcast program time is the entire duration of the broadcast program. The server digest time represents a total of the time designated in the intra-program recording index. The intra-program recording index is set according to the same rule as that for the intra-program recording index which is contained in the aforementioned program recording information, and represents periods of time within the program which are to be reproduced as a digest.

The “broadcast type” represents the image quality with which the program is supposed to have been broadcast. For example, the broadcast type would be set to “HD” for high image quality broadcast, “SD” for standard image quality broadcast, and “MB” for mobile-oriented (i.e., low) image-quality broadcast. The “codec type” represents encoding/decoding processes used for the program. The “composer” is information for identifying an individual or group that has created the digest information (name or identification mark). The “presence/absence of authentication” represents whether the server digest information has been authenticated by the composer, and is used to confirm whether the digest has been edited by the composer under his or her own responsibility (reliability confirmation). For example, the “presence/absence of authentication” would be set to “1” in the case where authentication is present, and “0” in the case where authentication is absent. The “bit rate” represents a degree of motion in the image, based on an average bit rate in the digest segments, and is used to confirm whether any scenes containing large and vigorous motions are used for the digest. The value of the average bit rate may itself be set as the bit rate, or a class of average bit rates (e.g., large, medium, small) may be set as the bit rate.

The“presence/absence of offset” indicates, in the case where the digest information is to be used for a program which has been recorded in a format other than that indicated by the codec type, whether there is an offset between the time in the actual program and the time in the digest. For example, “presence/absence of offset” would be set to “1” in the case where there is an offset, and “0” in the case where there is no offset. The “correction amounts” indicate amounts by which the respective points in time of the indices are to be corrected in the case where the “presence/absence of offset” indicates “1”. It may be conceivable for the composer to generate digest information while intentionally shifting the points in time of the respective segment indices, and offer information for correcting such shifts to be separately purchasable for a charge (digest scramble: DS). In this case, the offset information may be set to “2” or the like to notify to the user that the correction amounts are available for a charge.

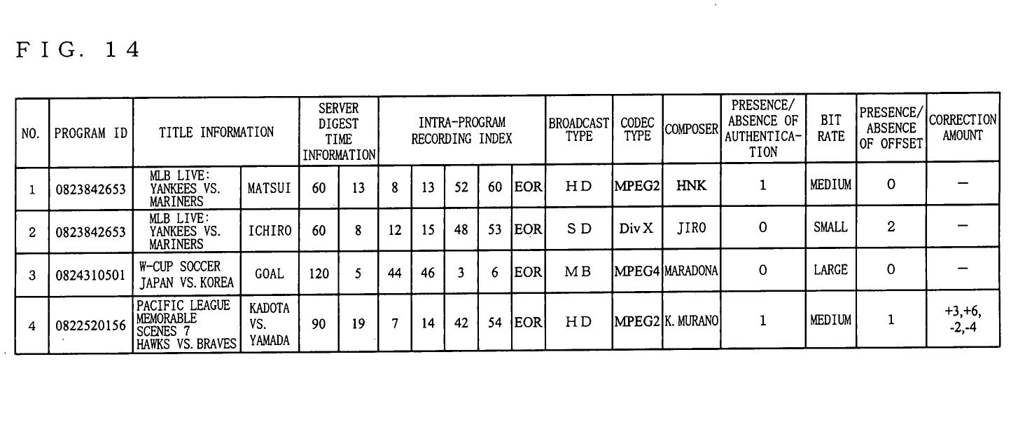

FIG. 14 illustrates an example of server digest information which is stored in the server 40. As shown in FIG. 14, in the server digest information, a plurality of pieces of digest information may exist corresponding to a given program ID. This is because digests are generated by a plurality of people (owners of the recording/reproduction apparatuses 20) from different points of view. One feature of the present invention is that, from among such a plurality of pieces of digest information which have been generated from various points of view, a piece of digest information having the optimum content can be selected for use.

In the example shown in FIG. 14, for a baseball program (program ID: 0823842653) whose broadcast program time is 60 minutes, there are two pieces of digest information: 13-minute-long digest information which combines scenes in which “Matsui” appears, and 8-minute-long digest information which combines scenes in which “Ichiro” appears. For a soccer program (program ID: 0824310501) whose broadcast program time is 120 minutes, there exists 5-minute-long digest information which combines “goal” scenes. Furthermore, for a baseball program (program ID: 0822520156) whose broadcast program time is 90 minutes, there exists 19-minute-long digest information which combines memorable scenes of “Kadota vs. Yamada”.

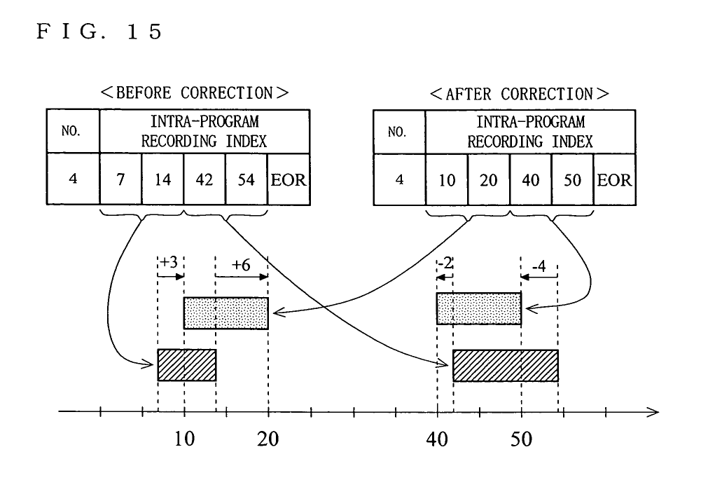

Now, the method for utilizing correction amounts will be described. FIG. 15 is a diagram for explaining a method for correcting an intra-program recording index in accordance with digest information correction amounts labeled No. 4 in FIG. 14. The correction amounts “+3, +6, −2, −4” represent correction amounts for “7,14,42,54”, respectively, in the intra-program recording index. Therefore, in the case where the codec type is other than MPEG2, the intra-program recording index is to be corrected to “10,20,40,50”. As described above, the correction amounts may be individually defined corresponding to the respective points in time in the intra-program recording index as described above, or all the points in time may be universally corrected based on a single piece of information.

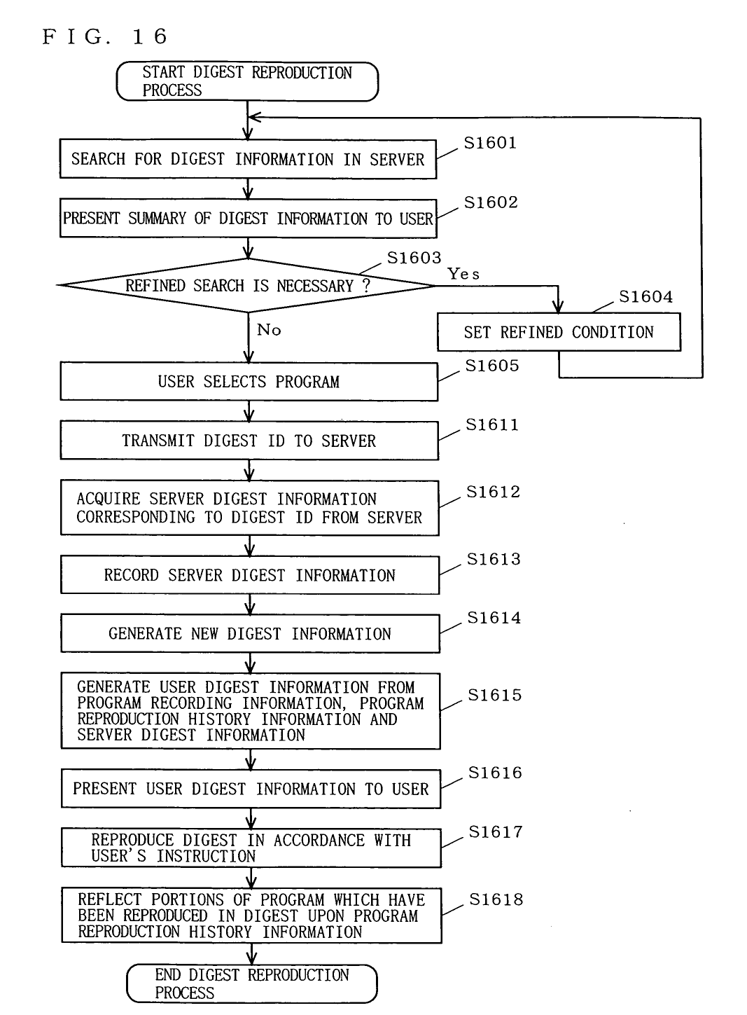

Hereinafter, with reference to FIG. 16, a procedure of searching for server digest information and a procedure of generating user digest information to be performed at the time of digest reproduction will be described. FIG. 16 is a flowchart illustrating a procedure of the digest reproduction process performed by the recording/reproduction apparatus 20 according to an embodiment of the present invention.

If an instruction to perform a search for digest information is received from the control section 22, the server digest information acquisition section 275 connects to the server 40 via the communication section 28 and the network 30, and searches for digest information which is registered in the server 40 (step S1601). Then, the server digest information acquisition section 275 presents to the user a summary of the found digest information by, for example, displaying it on an external TV screen via the display section 26 (step S1602). At this time, it is preferable that the server digest information acquisition section 275 refers to the program IDs which are recorded on the hard disk 25, and displays a summary of digest information which only relates to the recorded programs. FIG. 17 is a diagram illustrating an example of a search result screen.

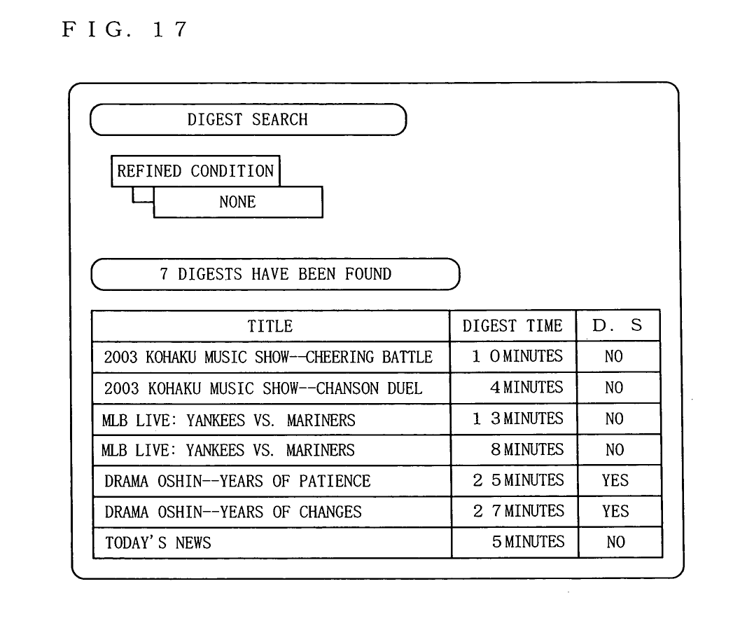

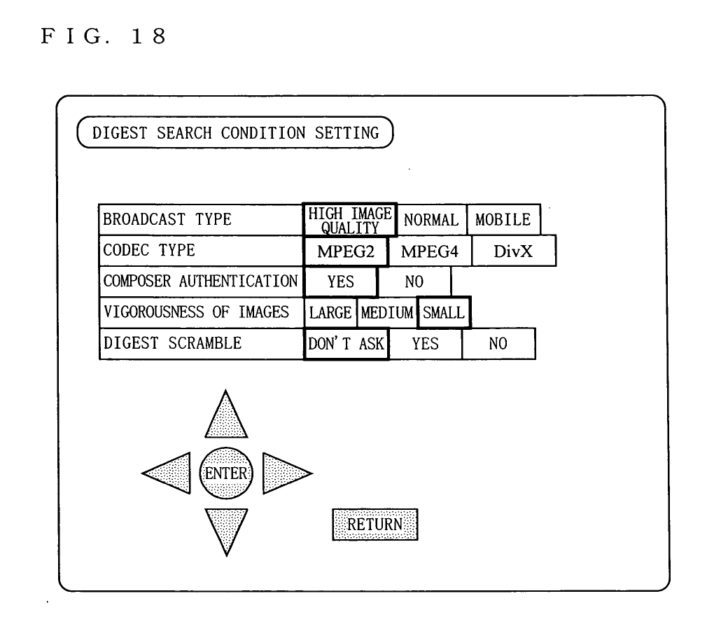

The user confirms this search result screen, and instructs the server digest information acquisition section 275 whether it is necessary to perform a further search based on refined conditions (step S1603). If a further search is necessary, refined conditions, i.e., reproduction condition information is set by the user, via a condition inputting screen as show in FIG. 18 (step S1604). Once the reproduction condition information is set, the server digest information acquisition section 275 performs a further search through the digest information registered in the server 40, and again presents a summary of the found digest information to the user (step S1601, S1602). FIG. 19 is a diagram illustrating an example of a further search result screen. If there is no need to perform a further search, the user selects a program which the user wants to reproduce in digest form from within the presented screen (step S1605). FIG. 19 illustrates a case where a program for which digest scramble is set is being selected. In this case, a screen for allowing the user to select whether or not to purchase information for disengaging digest scramble. In the case where a refined search is not to be performed by using reproduction condition information, steps S1601 to S1605 above may be omitted, and the process may be begun at the subsequent step S1611.

Once a program which is desired to be reproduced in digest form has been designated by the user, an instruction to acquire digest information for the designated program is issued from the control section 22 to the server digest information acquisition section 275. Upon receiving this acquisition instruction from the control section 22, the server digest information acquisition section 275 transmits the digest ID to the server 40 (step S1611). Upon receiving the digest ID from the server digest information acquisition section 275, the server 40 searches through the server digest information stored therein, and transmits a piece of server digest information which corresponds to the digest ID to the server digest information acquisition section 275. The server digest information acquisition section 275 acquires the server digest information which has been transmitted from the server 40 (step S1612). In the case where a plurality of pieces of server digest information are to be acquired, the above process is repeated.

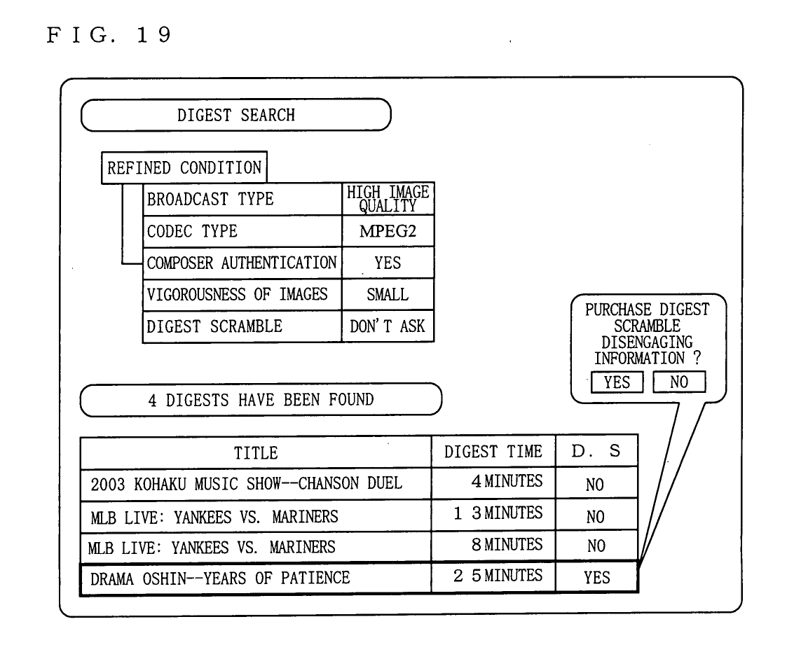

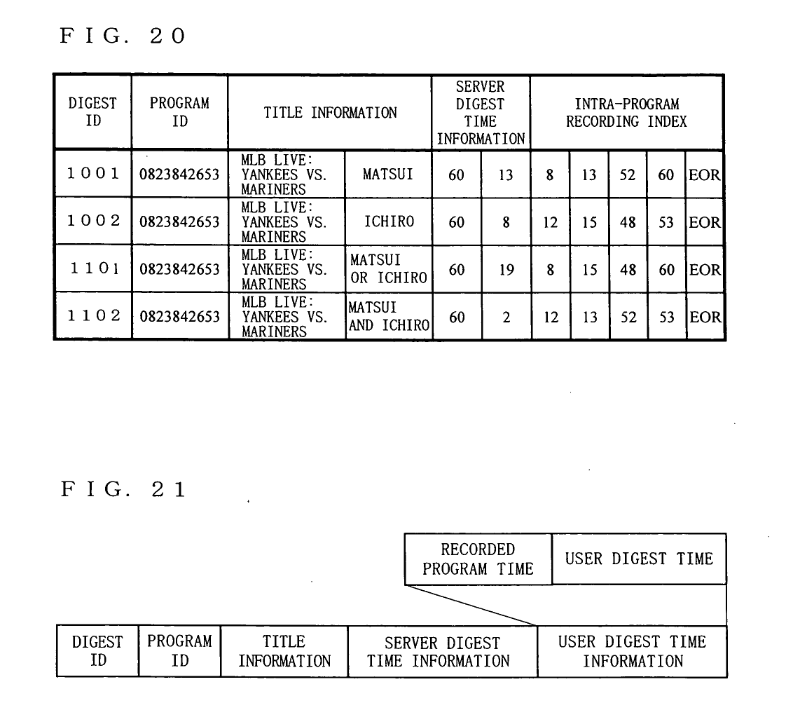

The server digest information management section 276 records every piece of the server digest information which has been acquired by the server digest information acquisition section 275 in a predetermined area of the hard disk 25, in the form of a server digest information table as shown in FIG. 20, for example (step S1613).

In the case where a plurality of pieces of server digest information exist for a given program, the server digest information management section 276 may create new pieces of digest information by utilizing such information (step S1614), such as logic OR digest information which combines a plurality of pieces of server digest information into one unit, and logic AND digest information which combines only overlapping portions among the plurality of pieces of server digest information into one unit. In the example shown in FIG. 20, the following two are newly generated: 19-minute-long logic OR digest information which combines scenes in which either “Matsui” or “Ichiro” appears, and 2-minute-long logic AND digest information which combines scenes in which both “Matsui” and “Ichiro” appear. Such newly-generated pieces of digest information (digest IDs “1101” and “1102”) are recorded in a predetermined area of the hard disk 25, together with the server digest information (digest IDs “1001” and “1002”) acquired from the server 40.

Once the server digest information is recorded to the hard disk 25, the user digest information generation section 277 generates pieces of user digest information, which correspond to the respective pieces of server digest information, by utilizing the program recording information, the program reproduction history information, and the server digest information (step S1615).

As shown in FIG. 21, the user digest information is composed of: a digest ID; a program ID; title information; server digest time information; and user digest time information, which includes a recorded program time and a user digest time. An intra-program recording index may be further added thereto. The digest ID is information which is added to the generated user digest information, and may be a serial number, for example. The program ID, the title information, and the server digest time information are identical to the respective kinds of information included in the aforementioned server digest information. The recorded program time represents a total of the time designated by the intra-program recording index in the program recording information. The user digest time is obtained as follows.

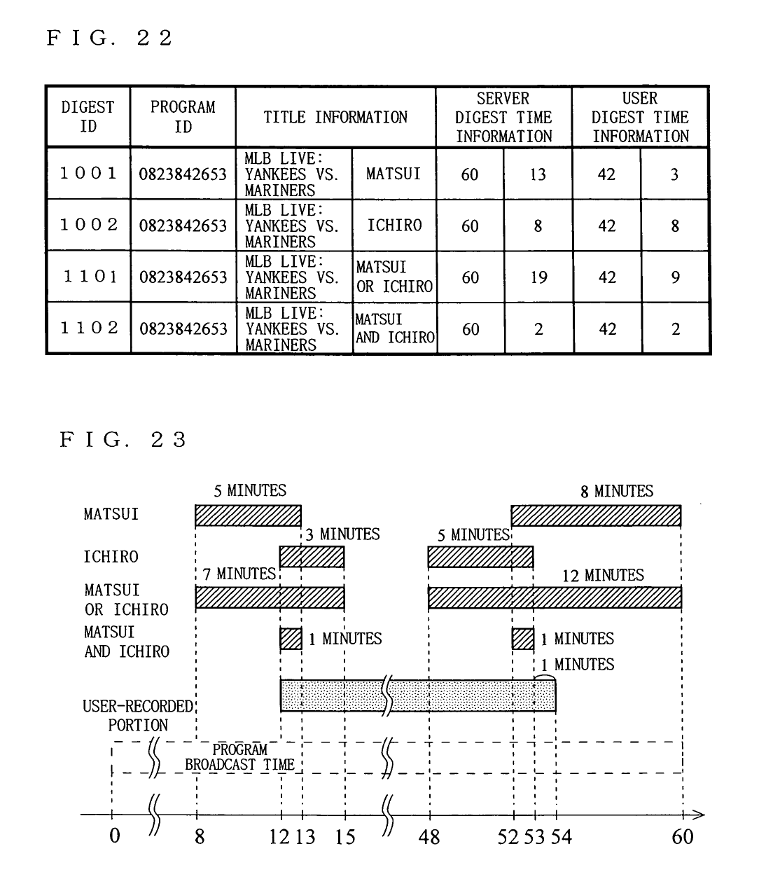

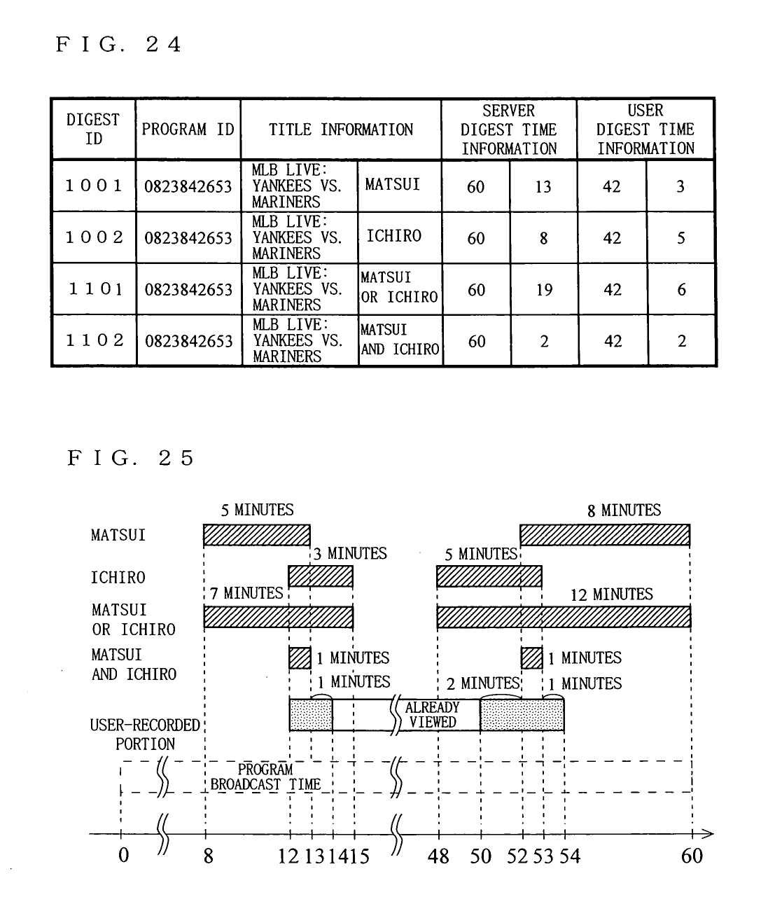

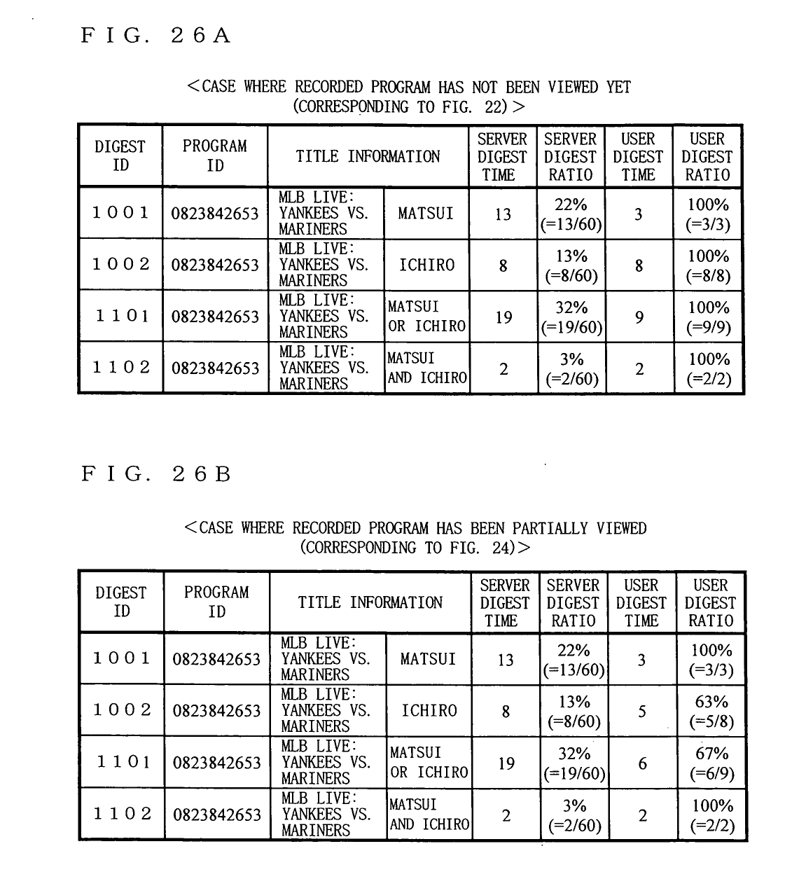

In the case where the recorded program has not been reproduced by the user, the user digest information generation section 277 detects coincidences between the points in time designated by the intra-program recording index in the program recording information and the points in time designated by the intra-program recording index in the server digest information, and defines a total time of such coinciding portions as the user digest time (FIG. 22 and FIG. 23). In other words, the intra-program recording index in the server digest information is edited based on the intra-program recording index in the program recording information. As a result, a digest time concerning a portion of the server digest information that is related to the recorded portion of the program is obtained.

In the case where the recorded program has been partially reproduced by the user, the user digest information generation section 277 detects coincidences between the points in time designated by the intra-program recording index in the program reproduction history information and the points in time designated by the intra-program recording index in the server digest information, and defines a total time of such coinciding portions as the user digest time (FIG. 24 and FIG. 25). In other words, the intra-program recording index in the server digest information is edited based on the intra-program recording index in the program reproduction history information. As a result, a digest time concerning a portion of the server digest information that is related to unreproduced (unviewed) portions of the recorded portion of the program is obtained.

Thereafter, the user digest information management section 278 presents to the user the user digest information which has been generated by the user digest information generation section 277 by, for example, displaying it on an external TV screen via the display section 26 (step S1616). From among the presented pieces of user digest information, the user selects a desired digest to be reproduced (step S1617). The portions of the program which have been viewed as a result of the digest reproduction are to be reflected upon the program reproduction history information (step S1618).

In order to provide enhanced convenience for the user, the proportion of the digest in the program may be included in the digest information, e.g., a ratio of the server digest time to the broadcast program time, or a ratio of the user digest time as ascertained from the program reproduction history information to the user digest time as ascertained from the program recording information (FIG. 26A and FIG. 26B). In FIG. 26A, it is possible to indicate to the user how condensed the digest is relative to the broadcast program time. In FIG. 26B, it is possible to indicate to the user, within the digest time which is known from the server digest information, an amount of time corresponding to a portion of the program which has not been viewed by the user.

Thus, in accordance with a recording/reproduction apparatus of an embodiment of the present invention, server digest information is acquired from the server 40 which is connected via the network 30, and based on this server digest information, user digest information corresponding to a portion of the program which has been recorded by the user (recorded segments) is generated. As a result, by utilizing a program digest created by a third party, the user of the recording/reproduction apparatus 20 can reproduce a digest that relates to a portion of the program which the user himself/herself has recorded. In particular, by previously narrowing down the target by using reproduction condition information prior to sending a program ID to the server, it becomes easy to acquire the desired digest information.

Moreover, in accordance with a recording/reproduction apparatus of an embodiment of the present invention, a plurality of pieces of user digest information are generated in the case where two or more pieces of server digest information are stored in the server 40 for a given program. As a result, the user is able to select a digest to be reproduced according to his or her preferences (contents of the digest) or viewing conditions (the amount of time which could be spent for digest reproduction). Thus, it is possible to meet various needs of the user, e.g., wanting to understand the contents of the program through a short digest due to lack of time.

Furthermore, in accordance with a recording/reproduction apparatus of an embodiment of the present invention, user digest information is generated so as to correspond to, within a portion of the program having been recorded by the user, only a portion that has not been viewed by the user (unreproduced segments). As a result, an effective digest reproduction can be realized which prevents redundant viewing, or missing portions of, the digest.

The present embodiment illustrates an example where the recording/reproduction apparatus 20 acquires server digest information from the server 40 to generate user digest information. Alternatively, the recording/reproduction apparatus 20 may transmit program recording information or program reproduction history information to the server 40, and, based on such information, the server 40 may generate user digest information (e.g., new digest information having digest segments which are obtained by subjecting digest-segment-representing information to a logical operation) and return it to the recording/reproduction apparatus 20.

The present embodiment illustrates an example where a start time and an end time which are taken as relative times from the program broadcast start time are set in each segment index in the intra-program recording index. Alternatively, in the case where a program to be broadcast from the broadcast station 10 is kept under management in split forms based on a predefined set of markers, the aforementioned function can be realized by setting markers in each segment index.

The functional blocks of the recording/reproduction apparatus according to the present invention, such as the control section 22, the recording/reproduction processing section 24, and the digest information management section 27, are typically implemented as an LSI, which is a type of integrated circuit (which may be referred to as an IC, a system LSI, a super LSI, or an ultra LSI, depending on the degree of integration) (see FIG. 2). Such functional blocks may be individually integrated into chips, or a single chip encompassing some or all of such functional blocks may be produced.

The circuit integration technique is not limited to LSIs. The integrated circuit may be implemented as a specially-designed circuit or a generic processor. Furthermore, the integrated circuit may be implemented by using an FPGA (Field Programmable Gate Array) which is capable of being programmed after the LSI is produced, or a reconfigurable processor (the interconnections and settings of circuit cells within the LSI can be reconfigured).

It will also be appreciated that, if advancements in semiconductor technology or any other technique branching off from semiconductor technology produces a circuit integration technique that replaces LSIs, the functional blocks may be integrated by using such a technique. Applications of biotechnology, for example, may be possible.

The reproduction method according to the present invention may be realized by predetermined program data for enabling the above-described processing procedures, stored in a storage device (a ROM, a RAM, a hard disk, or the like), being interpreted and executed by a CPU. In this case, the program data may be introduced to the storage device via a recording medium such as a CD-ROM or a flexible disk, or may be executed directly from a recording medium.

### INDUSTRIAL APPLICABILITY

The present invention contributes to, for example, an enhanced distribution of information concerning program digests which are produced by a broadcast station or a third party, and is especially of use when reproducing a recorded program in digest form, based on the above information, while taking into consideration factors such as unreproduced portions of the recorded program and the amount of time which a user can spend for viewing, for example.

1. A reproduction apparatus for performing a digest reproduction of a recorded program by referring to digest information, the recorded program being a recording of some or all segments of an original program, comprising:
a program recording information processing section operable to generate program recording information with respect to the recorded program, the program recording information containing information of recorded segments relative to the original program;
a communication section operable to communicate via a network with a server which stores digest information with respect to the original program, the digest information containing information of a digest segment to be used for the digest reproduction;
a server digest information processing section operable to compare the program recording information concerning the recorded program and the digest information corresponding to the recorded program, and acquire, from the server, digest information containing information of digest segments at least some of which coincide with the recorded segments; and
a reproduction processing section operable to reproduce the recorded program based on the digest information acquired by the server digest information processing section.

2. The reproduction apparatus according to claim 1, further comprising a user digest information processing section operable to generate new digest information based on the digest information acquired by the server digest information processing section, the new digest information containing information of a digest segment which is reproducible from the recorded program,
wherein the reproduction processing section is operable to reproduce the recorded program further based on the new digest information generated by the user digest information processing section.

3. The reproduction apparatus according to claim 2, further comprising a program reproduction history information processing section operable to generate, with respect to the recorded program, program reproduction history information containing information of an unreproduced segment, the unreproduced segment being one of the recorded segments which has not been reproduced yet,
wherein the user digest information processing section is operable to generate new digest information further based on the program reproduction history information, the new digest information being used for reproducing the unreproduced segment of the recorded program.

4. The reproduction apparatus according to claim 2,
wherein the user digest information processing section is operable to, with respect to a plurality of pieces of digest information stored in the server concerning a given recorded program, subject the digest segments contained in the plurality of pieces of digest information to a logical operation, and further generate new digest information containing information of a digest segment obtained as a result of the logical operation.

5. The reproduction apparatus according to claim 2,
wherein the information of the recorded segments and the information of the digest segment are time information described in terms of relative time from the beginning of the program.

6. The reproduction apparatus according to claim 3,
wherein the information of the recorded segments, the information of the digest segment, and the information of the unreproduced segment are time information described in terms of relative time from the beginning of the program.

7. The reproduction apparatus according to claim 1,
wherein,
the digest information includes a broadcast type concerning image quality of the program, and
the server digest information processing section is operable to determine which digest information to acquire by referring to the broadcast type.

8. The reproduction apparatus according to claim 1,
wherein,
the digest information includes a codec type concerning encoding/decoding processes used for the program, and
the server digest information processing section is operable to determine which digest information to acquire by referring to the codec type.

9. The reproduction apparatus according to claim 1,
wherein,
the digest information includes information identifying an individual or group that has created the digest information,
and the server digest information processing section is operable to determine which digest information to acquire by referring to the identifying information.

10. The reproduction apparatus according to claim 9,
wherein,
the digest information includes presence/absence of authentication concerning whether an authentication has been made by the individual or group that has created the digest information, and
the server digest information processing section is operable to determine which digest information to acquire by referring to the presence/absence of authentication.

11. The reproduction apparatus according to claim 1,
wherein,
the digest information includes a bit rate concerning motions within an image pertaining to the digest segment, and
the server digest information processing section is operable to determine which digest information to acquire by referring to the bit rate.

12. The reproduction apparatus according to claim 1,
wherein,
the digest information includes presence/absence of offset concerning whether there is an offset relative to the digest segment, and
the server digest information processing section is operable to determine which digest information to acquire by referring to the presence/absence of offset.

13. The reproduction apparatus according to claim 12,
wherein the digest information includes a correction amount for the digest segment in a case where there is an offset.

14. The reproduction apparatus according to claim 12,
wherein the presence/absence of offset includes information indicating that a correction amount for the digest segment in a case where there is an offset is available for a charge.

15. A reproduction method for performing a digest reproduction of a recorded program by referring to digest information, the recorded program being a recording of some or all segments of an original program, comprising the steps of:
generating program recording information with respect to the recorded program, the program recording information containing information of recorded segments relative to the original program;
communicating via a network with a server which stores digest information with respect to the original program, the digest information containing information of a digest segment to be used for the digest reproduction;
comparing the program recording information concerning the recorded program and the digest information corresponding to the recorded program, and acquiring, from the server, digest information containing information of digest segments at least some of which coincide with the recorded segments; and
reproducing the recorded program based on the digest information acquired by the server digest information processing section.

16. A computer-readable program for causing a computer to execute a method for performing a digest reproduction of a recorded program by referring to digest information, the recorded program being a recording of some or all segments of an original program, comprising the steps of:
generating program recording information with respect to the recorded program, the program recording information containing information of recorded segments relative to the original program;
communicating via a network with a server which stores digest information with respect to the original program, the digest information containing information of a digest segment to be used for the digest reproduction;
comparing the program recording information concerning the recorded program and the digest information corresponding to the recorded program, and acquiring, from the server, digest information containing information of digest segments at least some of which coincide with the recorded segments; and
reproducing the recorded program based on the digest information acquired by the server digest information processing section.

17. An integrated circuit for use in a reproduction apparatus for performing a digest reproduction of a recorded program by referring to digest information, the recorded program being a recording of some or all segments of an original program,
wherein the integrated circuit is incorporated in a reproduction apparatus having a communication section operable to communicate via a network with a server which stores digest information with respect to the original program, the digest information containing information of a digest segment to be used for the digest reproduction,
the integrated circuit comprising circuitry which functions as:
a program recording information processing section operable to generate program recording information with respect to the recorded program, the program recording information containing information of recorded segments relative to the original program;
a server digest information processing section operable to compare the program recording information concerning the recorded program and the digest information corresponding to the recorded program, and acquire, from the server, digest information containing information of digest segments at least some of which coincide with the recorded segments; and
a reproduction processing section operable to reproduce the recorded program based on the digest information acquired by the server digest information processing section.
